(19) United States
(12) Patent Application Publication
(10) Pub. No.: US 2025/0168956 A1
(43) Pub. Date: May 22, 2025

(54) A METHOD AND AN ARRANGEMENT FOR OUTPUT CONFIGURATION OF A NETWORK DEVICE

(71) Applicant: LumenRadio AB, Göteborg (SE)

(72) Inventor: Niclas NORLÉN, Uddevalla (SE)

(73) Assignee: LumenRadio AB, Göteborg (SE)

(21) Appl. No.: 18/832,595

(22) PCT Filed: Jan. 26, 2023
(86) PCT No.: PCT/SE2023/050068

§ 371 Date: Jul. 24, 2024

(30) Foreign Application Priority Data
Jan. 28, 2022 (SE) 2250077-1

(51) Int. Cl. H05B 47/18

(52) U.S. Cl. CPC H05B 47/18

(57) ABSTRACT

The present invention relates to a method (200) for output configuration of a network device (101;300;400,410,420,430) by means of a portable configurator (102), wherein the network device has at least two outputs (101:0-11;D0:1-3,D1:1-3) connected to a respective output device (103a-d, 104a-d, 105a-d; 301a-b,302a-b,303a-b), wherein each output device has a characteristic output signal (α,β,γ), the method comprising a) initiating (S10) communication between the network device and the portable configurator; b) activating (S20) at least one of the output devices with respective output of the network device; c) detecting (S30) each characteristic output signal for each activation of the output devices; d) transmitting (S40) information related to the detected output signal from the portable configurator to the network device; c) storing (S50) the detected output signals mapping to respective output of the network device.

### TECHNICAL FIELD

The present disclosure generally relates to the field of output configuration of a network device, and more specifically to output configuration of a network device with a portable configurator.

### BACKGROUND

If a network device has many outputs connected to different output devices with different output characteristics it might be problematic to correct an erroneously connected output device, due to difficulties in accessing the network device for rerouting the cables to the output devices. This scenario occurs frequently in lighting applications. For example if a network device is mounted high above the ground and a LED device of the wrong color is connected to an output an electrician needs to reroute the cables between the network device and the output device and this might involve the use of a sky lift and an increased risk of injuries. In today's lighting applications, there is an increased use of LED drivers controlled by a communication bus, and these LED drivers often assign different outputs to different LED colors. This means that if a LED driver from one manufacturer is replaced with a LED driver from another manufacturer there is a large risk that the output color is wrong for that LED driver, and this might initiate the need of a re-configuration of the driver by means of physically connecting a computer directly to the LED-driver. In other lighting applications it is common to reconfigure a driver by means of flipping DIP-switches on the LED driver for example. Both these examples of reconfigurations require direct physical access to the driver and this is cumbersome in many applications.

### SUMMARY

An object of the present disclosure is to provide a method for output configuration of a network device which seeks to mitigate, alleviate, or eliminate one or more of the above-identified deficiencies in the art and disadvantages singly or in any combination and to provide an improved arrangement for output configuration.

This object is obtained by a method for output configuration of a network device by means of a portable configurator, wherein the network device has at least two outputs connected to a respective output device, wherein each output device has a characteristic output signal, the method comprising:
a) Initiating communication between the network device and the portable configurator.
b) Activating at least one of the output devices with respective output of the network device.
c) Detecting each characteristic output signal for each activation of the output devices.
d) Transmitting information related to the detected output signal from the portable configurator to the network device.
e) Storing the detected output signals mapping to respective output of the network device.

The object is also obtained by an arrangement for output configuration of a network device and a portable configurator. The network device comprises at least two outputs connected to a respective output device, each output being configured to activate its respective output device. Each output device is configured to emit a characteristic output signal upon activation. The network device further comprises a communication circuit configured to communicate with the portable configurator. The portable configurator comprises a communication circuit configured to communicate with the communication circuit of the network device, wherein the communication circuit of the portable configurator is configured to initiate communication with the network device, or the communication circuit of the network device is configured to initiate communication with the portable configurator. The network device is configured to activate at least one of the output devices with respective output of the network device. The portable configurator is configured to detect each characteristic output signal for each activation of the output devices, and for transmitting information related to the detected output signal from the portable configurator to the network device. The network device is further configured to store the detected output signals mapping to respective output of the network device.

This way there is a reduced need to physically access the network device for reconfiguration and rerouting, since the portable configurator allows remote configuration of the outputs of the network device to the output devices.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a schematic drawing of an arrangement for output configuration according to one embodiment;

FIG. 2 is a flowchart illustrating a method for output configuration according to one embodiment;

FIG. 3 is schematic drawing of an arrangement for output configuration of a network device with a luminaire according to one embodiment;

FIG. 4 is a schematic drawing of a meshed network of network devices and output configuration of one of the network devices according to one embodiment; and

FIG. 5 shows an exemplary hardware implementation of the network device shown in FIG. 1.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

Some of the example embodiments presented herein are directed towards output configuration of a network device. As part of the development of the example embodiments presented herein, a problem will first be identified and discussed.

If a network device has a many outputs connected to different output devices with different output characteristics it might be problematic to correct an erroneously connected output device, due to difficulties in accessing the network device for rerouting the cables to the output devices. These difficulties may for example involve a placement of the network device high above the ground plane. Other difficulties would be that the cables between the network device and the output devices are not accessible without dismounting the housings of the connectors and rearranging the pins in the connector, which involves extra time and work.

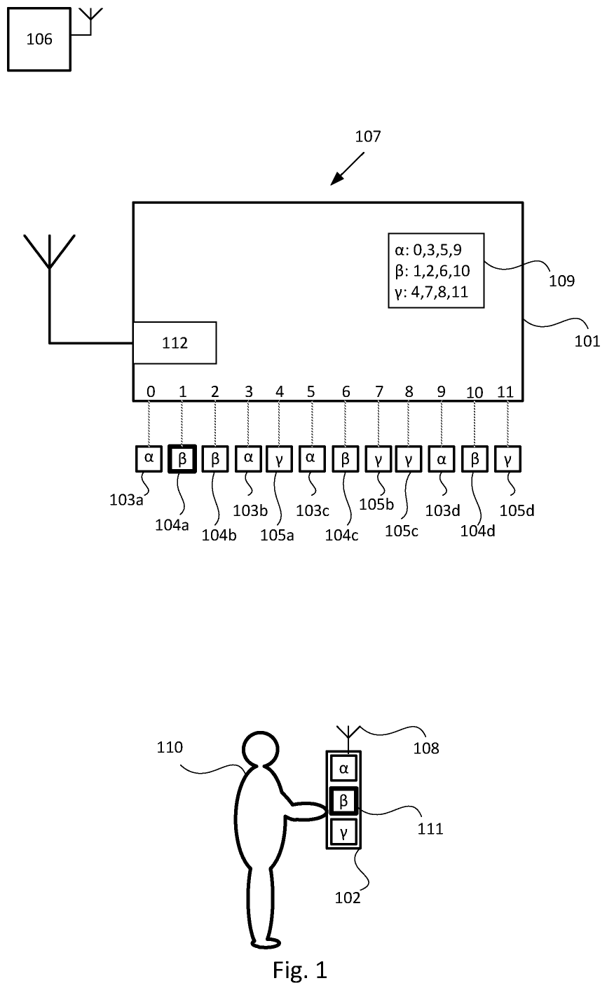

The present inventor realized that these problems might be minimized or even eliminated by a method 200 for output configuration of a network device, generally designated 101 in FIG. 1, by means of a portable configurator 102. The network device has at least two outputs 101:0-11 connected to a respective output device 103a-d, 104a-d, 105a-d, wherein each output device has a characteristic output signal α,β,γ as shown in FIG. 1.

The method comprising:
a) Initiating S10 communication between the network device and the portable configurator. This may involve establishing a radio connection between the network device and the portable configurator. This radio connection may be a Bluetooth connection.
b) Activating S20 at least one of the output devices with respective output of the network device. For example an unconfigured output device may be activated or a new output device may be activated.
c) Detecting S30 each characteristic output signal for each activation of the output devices. This detection may be performed either by an operator 110 of the portable configurator 102, or by the portable configurator itself by means of for example an image sensor directed towards the output devices.
d) Transmitting S40 information related to the detected output signal from the portable configurator to the network device.
e) Storing S50 the detected output signals mapping to respective output of the network device. This mapping may be stored in a look-up table 109 in the network device 101.

Optionally, the step c) above may in one embodiment further comprise a step c1) registering S35 the detected output signal in the portable configurator 102. The operator 110 may perform this registering in that a button 111 of the portable configurator 102 with the corresponding output signal is pressed when the operator detects an output signal from an output device. For example output signals may be light of different colors, or light with different blinking frequencies. Sound signals may also be used as output signals.

Optionally, the step a) further comprises a step a1) receiving S15 information about the characteristic output signals at the portable configurator from the network device. This way an adaptive configuration of the portable configurator is possible since the network device sends information about possible output signals to the portable configurator. If the network device is not capable to detect which possible output signals that are available, the operator may configure the portable configurator manually by indicating possible output signals.

Now with reference made to FIGS. 1, 2 and 4.

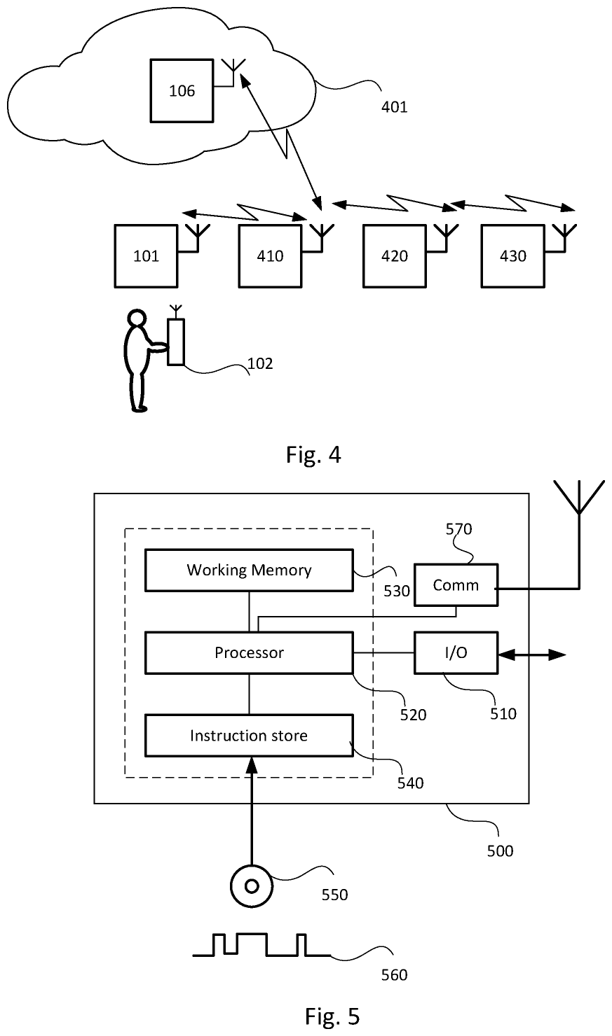

Optionally, the method 200 further comprises a step f) of transmitting S60 the stored detected output signals mapping to respective output to a network controller 106 from the network device after said step of storing S50. The network controller 106 may be a device or a cloud 401 functionality as disclosed in FIG. 4. The network controller may be connected to a network device 410 acting as a gateway to a number of network devices 101,420,430 in a network. The stored detected output signals mapping may be relayed to a service in cloud 401.

Now with reference made to FIG. 1, an embodiment of an arrangement 107 for output configuration of a network device 101 and a portable configurator 102 will be described. The network device comprises at least two outputs 101:0-11 connected to a respective output device 103a-d,104a-d,105a-d each output being configured to activate its respective output device. Each output device is configured to emit a characteristic output signal α, β, γ upon activation.

The network device 101 further comprises a communication circuit 112 configured to communicate with the portable configurator 102. The portable configurator 102 comprises a communication circuit 108 configured to communicate with the communication circuit 112 of the network device 101, wherein the communication circuit of the portable configurator is configured to initiate communication with the communication circuit of the network device, or the communication circuit of the network device is configured to initiate communication with the portable configurator. The network device is configured to activate at least one of the output devices with respective output of the network device. The portable configurator is configured to detect each characteristic output signal for each activation of the output devices, and for transmitting information related to the detected output signal from the portable configurator to the network device, and wherein the network device is configured to store the detected output signals mapping to respective output of the network device. The stored detected output signals mapping to respective output of the network device may be stored in a look-up table 109 in the network device.

Optionally, the portable configurator 102 is configured to register the detected output signal. The operator 110 may perform this registering in that a button 111 of the portable configurator 102 with the corresponding output signal is pressed when the operator detects an output signal from an output device.

Optionally, the portable configurator is configured to receive information about the characteristic output signals from the network device. This way an adaptive configuration of the portable configurator is possible since the network device sends information about possible output signals to the portable configurator. If the network device is not capable to detect which possible output signals that are available, the operator may configure the portable configurator manually by indicating possible output signals through a user interface of the portable configurator.

Optionally, the network device is configured to transmit the stored detected output signals mapping to respective output to a network controller. The network controller 106 may be a device or a cloud 401 functionality as disclosed in FIG. 4. The network controller may be connected to a network device 410 acting as a gateway to a number of network devices 101,420,430 in a network. The stored detected output signals mapping may be relayed to a service running in the cloud 401.

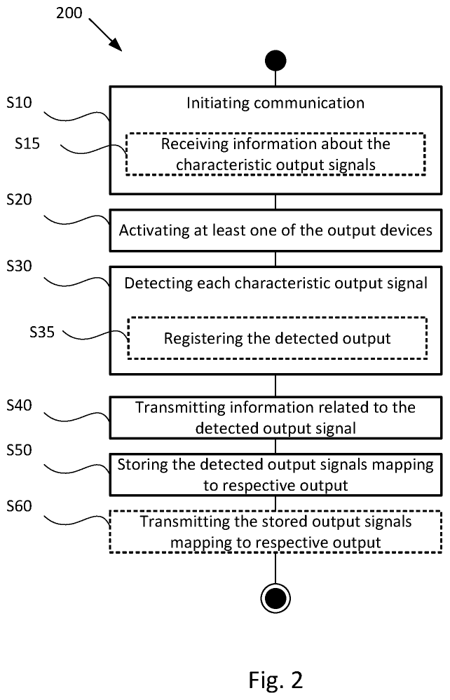

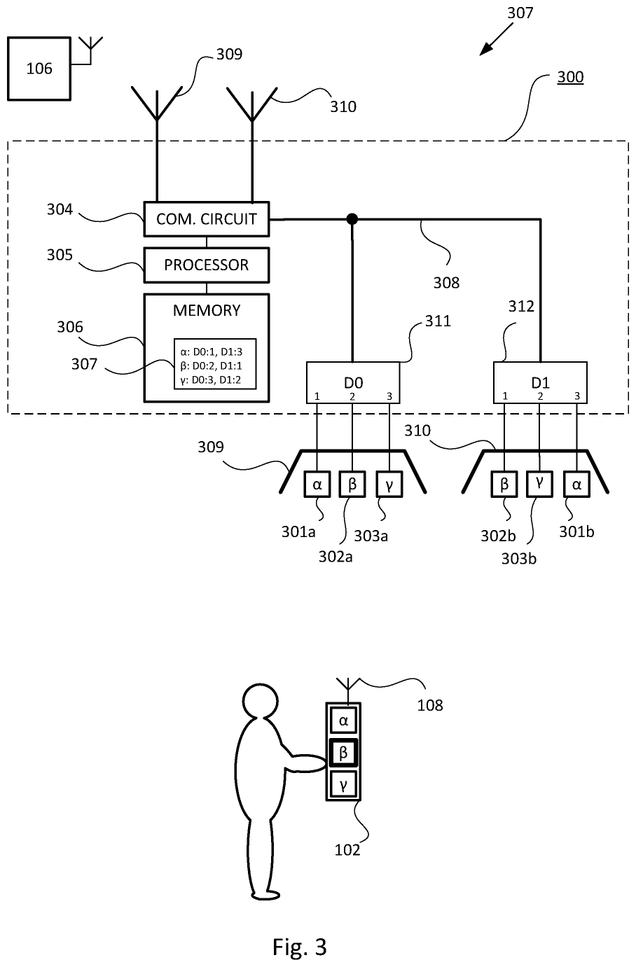

Now with reference made to FIG. 3 an embodiment of an arrangement 307 will be disclosed. This embodiment differs from the embodiment disclosed with reference to FIG. 1 above, in that the network device 300 comprises at least one driver 311,312 with said at least two outputs 301a-b,302a-b,303a-b wherein the at least one driver 311,312 is connected to a communication bus 308 for communication with the communication circuit 304. The network device 300 comprises a processor 305 and a computer readable memory 306, which comprises instructions to cause the processor to perform the method 200 disclosed above with reference made to FIG. 2. The memory 306 also comprises the look-up table 307. The processor 305 is connected to a communication circuit 304 that comprises a first circuit 309 for communication with other network devices and/or network controllers 106. The communication circuit also comprises a second circuit 310 for communication with the portable configurator 108

Optionally, the communication bus 308 is an analogue bus. An example of such a bus is 0-10V bus commonly used in USA for lighting applications.

Optionally, the communication bus 308 is a serial bus. An example of such a serial bus is the DALI bus commonly used in Europe for intelligent lighting applications.

Optionally, as disclosed in FIG. 3 the at least one driver 311,312 is a driver for a luminaire 309,310 and wherein the output devices 301a-b,302a-b,303a-b are light sources of the luminaire.

The light sources of the luminaire are LED devices in this example, and the characteristic output signal from the luminaire is light with different color for each LED device. For example, a may represent red light, B may represent green light and y may represent blue light.

In some embodiments, the output signal may be light or sound signals. For example in an industrial setting the output signal from an output device in form of a motor or an actuator, may be a light or sound signal that may be detected by the operator holding the portable configurator. It is also possible to have a fully automated output configuration if the portable configurator comprises a detector for the output signal. If the portable configurator comprises such a detector, the output signals from the output devices may not necessarily be detectable by an operator, such an output signal may for example be radio signals emitted by the output devices, or IR signals.

FIG. 5 shows an exemplary implementation of the network device 500, in programmable signal processing hardware. The network device 500 shown in FIG. 5 comprises an input/output (I/O) section 510 connected to the output devices. The network device 500 further comprises a processor 520, a working memory 530 and an instruction store 540 storing computer-readable instructions which, when executed by the processor 320, cause the processor 320 to perform the processing operations described hereinabove with reference to the flowchart in FIG. 2. The instruction store 540 may comprise a ROM which is pre-loaded with the computer-readable instruct ions. Alternatively, the instruction store 540 may comprise a RAM or similar type of memory, and the computer readable instructions can be input thereto from a computer program product, such as a computer-readable storage medium 550 such as a CD-ROM, etc. or a computer-readable signal 560 carrying the computer-readable instructions.

The disclosure relates to a method for output configuration of a network device by means of a portable configurator, wherein the network device has at least two outputs connected to a respective output device, wherein each output device has a characteristic output signal, the method comprising a) initiating communication between the network device and the portable configurator; b) activating at least one of the output devices with respective output of the network device; c) detecting each characteristic output signal for each activation of the output devices; d) transmitting information related to the detected output signal from the portable configurator to the network device; e) storing the detected output signals mapping to respective output of the network device.

According to some embodiments, the step c) further comprises a step: c1) registering the detected output signal in the portable configurator.

According to some embodiments, the step a) further comprises a step: a1) receiving information about the characteristic output signals at the portable configurator from the network device.

According to some embodiments, the method further comprises a step f) of transmitting the stored detected output signals mapping to respective output to a network controller from the network device after said step of storing.

The disclosure also relates to an arrangement for output configuration of a network device and a portable configurator, wherein the network device comprises: at least two outputs connected to a respective output device, each output being configured to activate its respective output device, wherein each output device is configured to emit a characteristic output signal upon activation; a communication circuit configured to communicate with the portable configurator; wherein the portable configurator comprises a communication circuit configured to communicate with the communication circuit of the network device, wherein the communication circuit of the portable configurator is configured to initiate communication with the network device, or the communication circuit of the network device is configured to initiate communication with the portable configurator; wherein the network device is configured to activate at least one of the output devices with respective output of the network device; wherein the portable configurator is configured to detect each characteristic output signal for each activation of the output devices, and for transmitting information related to the detected output signal from the portable configurator to the network device; and wherein the network device is configured to store the detected output signals mapping to respective output of the network device.

According to some embodiments, the portable configurator is configured to register the detected output signal.

According to some embodiments, the portable configurator is configured to receive information about the characteristic output signals from the network device.

According to some embodiments, the network device is configured to transmit the stored detected output signals mapping to respective output to a network controller.

According to some embodiments, the network device comprises at least one driver with said at least two outputs, wherein the at least one driver is connected to a communication bus for communication with the communication circuit.

According to some embodiments, the communication bus is an analogue bus.

According to some embodiments, the communication bus is a serial bus.

According to some embodiments, herein the at least one driver is a driver for a luminaire and wherein the output devices are light sources of the luminaire.

According to some embodiments, the light sources of the luminaire are LED devices.

According to some embodiments, the characteristic output signal from the luminaire is light with different color for each LED device.

The disclosure also relates to a computer-readable storage medium storing computer program instructions which, when executed by a processor, cause the processor to perform a method as disclosed above.

The disclosure also relates to a signal carrying computer program instructions which, when executed by a processor, cause the processor to perform a method as disclosed above.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products.

It should be appreciated that the example embodiments presented herein may be practiced in any combination with each other. It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

1. A method for output configuration of a network device by means of a portable configurator, wherein the network device has at least two outputs connected to a respective output device, wherein each output device has a characteristic output signal, the method comprising:
a) initiating communication between the network device and the portable configurator;
b) activating at least one of the output devices with respective output of the network device;
c) detecting each characteristic output signal for each activation of the output devices;
d) transmitting information related to the detected output signal from the portable configurator to the network device; and
e) storing the detected output signals mapping to respective output of the network device.

2. The method according to claim 1, wherein c) further comprises:
c1) registering the detected output signal in the portable configurator.

3. The method according to claim 1, wherein a) further comprises:
a1) receiving information about the characteristic output signals at the portable configurator from the network device.

4. The method according to claim 1, further comprising:
f) transmitting the stored detected output signals mapping to respective output to a network controller from the network device after e).

5. An arrangement for output configuration of a network device and a portable configurator,
wherein the network device comprises:
at least two outputs connected to a respective output device, each output being configured to activate its respective output device, wherein each output device is configured to emit a characteristic output signal (α,β,γ) upon activation; and
a communication circuit configured to communicate with the portable configurator;
wherein the portable configurator comprises:
a communication circuit configured to communicate with the communication circuit of the network device;
wherein the communication circuit of the portable configurator is configured to initiate communication with the network device, or the communication circuit of the network device is configured to initiate communication with the portable configurator;
wherein the network device is configured to activate at least one of the output devices with respective output of the network device;
wherein the portable configurator is configured to detect each characteristic output signal for each activation of the output devices, and for transmitting information related to the detected output signal from the portable configurator to the network device; and
wherein the network device is configured to store the detected output signals mapping to respective output of the network device.

6. The arrangement according to claim 5, wherein the portable configurator is configured to register the detected output signal.

7. The arrangement according to claim 5, wherein the portable configurator is configured to receive information about the characteristic output signals from the network device.

8. The arrangement according to claim 5, wherein the network device is configured to transmit the stored detected output signals mapping to respective output to a network controller.

9. The arrangement according to claim 5, wherein the network device comprises at least one driver with the at least two outputs; and
wherein the at least one driver is connected to a communication bus for communication with the communication circuit.

10. The arrangement according to claim 9, wherein the communication bus is an analogue bus.

11. The arrangement according to claim 9, wherein the communication bus is a serial bus.

12. The arrangement according to claim 9, wherein the at least one driver is a driver for a luminaire; and
wherein the output devices are light sources of the luminaire.

13. The arrangement according to claim 12, wherein the light sources of the luminaire are LED devices.

14. The arrangement according to claim 13, wherein the characteristic output signal from the luminaire is light with different color for each LED device.

15. A computer-readable storage medium storing computer program instructions which, when executed by a processor, cause the processor to perform a method according to claim 1.

16. A signal carrying computer program instructions which, when executed by a processor, cause the processor to perform a method according to claim 1.
